(19) United States
(12) Patent Application Publication
(10) Pub. No.: US 2015/0180091 A1
(43) Pub. Date: Jun. 25, 2015

(54) ACCUMULATOR BATTERY PROTECTED AGAINST EXTERNAL SHORT-CIRCUITS

(71) Applicant: Commissariat à I'énergie atomique et aux énergies alternatives, Paris (FR)

(72) Inventors: Jérémy Dupont, Bourgoin-jaillieu (FR); Sébastien Carcouet, Vif (FR); Daniel Chatroux, Teche (FR)

(21) Appl. No.: 14/407,528

(22) PCT Filed: Jun. 7, 2013
(86) PCT No.: PCT/EP2013/061866

§ 371 Date: Dec. 12, 2014

(30) Foreign Application Priority Data
Jun. 12, 2012 (FR) 1255496

(51) Int. Cl. H01M 10/42; H01M 10/052

(52) U.S. Cl. CPC H01M 10/4257; H01M 10/052; H01M 2010/4271; H01M 2200/00; H01M 2220/20

(57) ABSTRACT

A power battery having electrochemical accumulators connected in series between two output terminals (B1, B2). There is a switch allowing one of the output terminals to be selectively isolated from an electrical load. There is a detection circuit for detecting an external short-circuit, to which the voltage between the output terminals of the battery is applied. The detection circuit is configured to compare the applied voltage to a voltage threshold representative of a short-circuit and to generate a signal for opening said switch when the applied voltage drops below the threshold.

### RELATED APPLICATIONS

This application is a U.S. National Stage of international application number PCT/EP2013/061866 filed Jun. 7, 2013, which claims the benefit of the priority date of French Patent Application FR 1255496, filed Jun. 12, 2012, the contents of which are herein incorporated by reference.

### FIELD OF INVENTION

The invention relates to electrochemical accumulator batteries. The latter may for example be used in the field of electric and hybrid vehicles or in on-board systems.

### BACKGROUND

Hybrid combustion/electric or electric vehicles especially include high-power batteries. Such batteries are used to drive an electric AC motor by way of an inverter. The voltage level required by such motors can be as high as several hundred volts and is typically about 400 volts. Such batteries also have a high capacity in order to increase the range of the vehicle in electric mode.

In order to obtain high powers and capacities, a plurality of groups of accumulators are placed in series. In order to make the battery easier to manufacture and handle, the accumulators are generally grouped into a plurality of modules that are connected in series. The number of stages in a module and the number of accumulators in parallel in each stage vary depending on the voltage, current and capacity desired for the battery. The electrochemical accumulators used in such vehicles are generally lithium-ion batteries, for their capacity to store a large amount of energy with a limited weight and volume. Lithium-ion iron phosphate LiFePO₄ battery technologies have been the subject of substantial development because of their intrinsically high safety level, to the detriment of a slightly lower energy storage density. An electrochemical accumulator usually has a nominal voltage of the following order of magnitude:

3.3 V for a lithium-ion iron phosphate (LiFePO₄) technology; and

4.2 V for a lithium-ion technology based on cobalt oxide.

Document U.S. Pat. No. 6,265,846 describes a circuit for protecting a battery of electrochemical accumulators for electrically isolating a defective accumulator from the rest of the accumulators forming a battery. Specifically, this document describes measuring the voltage across the terminals of each of the accumulators of the battery in order to detect a deep discharge of one of these accumulators. Such a protection circuit is unsuitable for detecting an external short-circuit across the terminals of the battery.

Given the amounts of energy stored in power batteries intended to provide automotive vehicles with motive power, failure of such batteries may have considerable consequences.

A first type of potential failure is the appearance of a short-circuit inside an accumulator. Very large currents, delivered by other accumulators of the battery, may then flow through the accumulator, which may lead to excessive heating and destruction thereof. Such heating or destruction may on the one hand cause the vehicle to stop, because of a loss of the supply of power to the electric motor. Such heating may also lead to sequential failure of adjacent accumulators, which may in turn be deteriorated by the heat generated in the failing accumulator.

A second type of potential failure is the appearance of an external short-circuit across the terminals of the battery or of one of its modules. In order to limit the consequences of such a short-circuit, the battery or each module comprises a series-connected fuse. During such a short-circuit, one or more fuses cut the series connection with the inverter, thereby allowing the amount of energy dissipated in the battery, or in the electrical elements that are connected thereto, to be limited.

Protection circuits have been proposed for short-circuiting any defective modules when a short-circuit is detected to have appeared by a control circuit. Such control circuits especially ensure the continuity of service of the battery in the presence of a defective module.

However, because of the low internal inductance of such a battery, an external short-circuit results in a very rapid increase in the current flowing therethrough. The time taken to heat and open fuses may then proved to be too long to prevent deterioration of protection circuits, or deterioration of electrical elements that are connected to the battery, or even deterioration of the battery. The consequences of such heating may therefore also extend to destruction of the battery and to the outbreak of a fire in the vehicle.

In order to increase the speed with which an external short-circuit is detected, it has been proposed to measure the current flowing through each module. In order to prevent the deterioration of the protection circuits of each module, each of these modules must be provided with its own circuit for measuring current. In order to determine the current flowing through each module in a reduced time, it is especially known to join a Hall-effect sensor thereto, or to place a shunt resistance in series with this module. When the measured current flowing through a module exceeds a threshold, the battery is disconnected from the inverter. Such current measurements result in very high wiring complexity, a considerable increase in the cost of the battery, and large thermal losses in the case of a shunt resistance.

### SUMMARY

The invention aims to solve one or more of these drawbacks. Thus, the invention relates to a power battery such as defined in the appended claims.

Other features and advantages of the invention will become more clearly apparent from the description that is given thereof below, by way of completely non-limiting example, with reference to the appended drawings.

### BRIEF DESCRIPTION OF THE DRAWINGS

FIG. 1 is a schematic representation of a vehicle equipped with an electrochemical battery power supply according to the invention;

FIG. 2 is a schematic representation of an example of a module equipped with an isolating circuit, destruction of which is prevented by the invention;

FIG. 3 is a circuit diagram of a first variant of the short-circuit-detecting device connected to the terminals of a module;

FIG. 4 is a graph illustrating operation of the detecting device in various charge configurations of a battery;

FIG. 5 is a circuit diagram of a second variant of the short-circuit-detecting device connected to the terminals of a module; and

FIG. 6 is a circuit diagram of a third variant of the short-circuit-detecting device connected to the terminals of a module.

### DETAILED DESCRIPTION

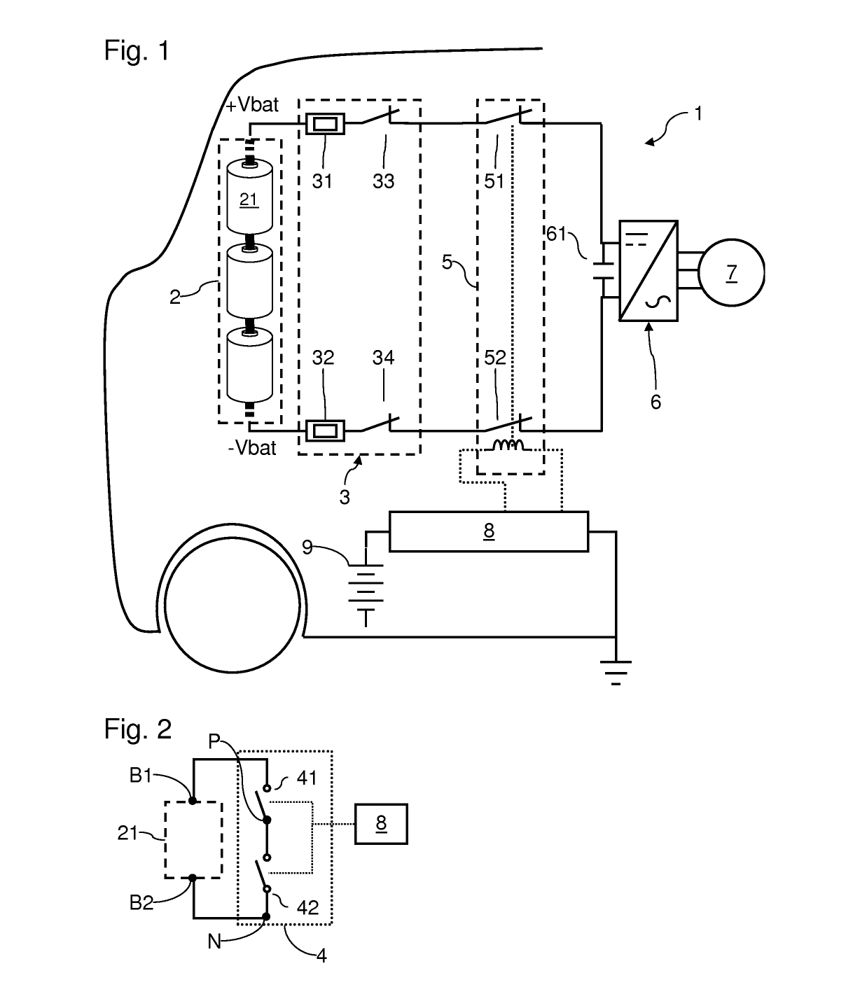

FIG. 1 illustrates one example vehicle 1 implementing one embodiment of the invention. The vehicle 1 is an electric vehicle comprising, as is known per se, a power battery 2 including modules 21 containing electrochemical accumulators, for example lithium-ion iron phosphate (LiFePO₄) accumulators, connected in series. The battery 2 is advantageously made up of modules connected in series in order to make its assembly and monitoring easier. A power battery the nominal voltage of which is generally higher than 100 V will typically comprise a plurality of modules 21 connected in series. Each module 21 may comprise a plurality of series-connected accumulator stages, each stage including a plurality of parallel-connected accumulators. A module 21 may comprise a large number of series-connected accumulators depending on the required voltage and the type of accumulators used.

The voltage across the terminals of the charged battery 2 is typically about 400 V. The battery 2 applies a voltage +Vbat to a first terminal, and a voltage −Vbat to a second terminal. The modules 21 are series-connected by way of power electrical connections. The terminals of the battery 2 are connected to a DC interface of an inverter 6. An electric motor 7 is connected to an AC interface of the inverter 6.

The terminals of the battery 2 and the DC interface of the inverter 6 are connected by way of a high-voltage bus equipped with a protection circuit 3 and by way of a power coupling circuit 5. The protection circuit 3 may comprise, as is known per se, fuses 31 and 32 configured to open the connection during a short-circuit. The protection circuit 3 furthermore comprises disconnectors 33 and 34 allowing the battery 2 to be disconnected in order to make it safe, in a way that is both reliable and visually verifiable, during service and maintenance of the vehicle 1.

The power coupling circuit 5 comprises switches 51 and 52 allowing the terminals of the battery 2 to be selectively connected/disconnected to/from the DC interface of the inverter 6. The power coupling circuit 5 comprises switches 51 and 52 allowing the terminals of the battery 2 to be selectively connected/disconnected to/from the DC interface of the inverter 6. The switches 51 and 52 are made to open/close by a control circuit 8, typically a processor for monitoring the operation of the battery 2. The control circuit 8 closes the switches 51 and 52 only when the vehicle is ready to start. The switches 51 and 52 may be used to interrupt the power supply of the motor 7 in the case of a malfunction.

The control circuit 8 is typically supplied by way of a battery 9 for powering the on-board electricals of the vehicle 1, having a voltage level very much lower than that of the battery 2. The control circuit 8 is typically connected to mechanical ground, including the chassis and the metal body of the vehicle 1.

The inverter 6 typically includes 6 IGBT transistors forming three switching arms, and the motor 7 is advantageously supplied directly by this inverter 6. A decoupling capacitor 61 of a few hundred microfarads is placed in parallel with the inverter 6. This capacitor 61 is used to decouple the voltage in order to minimize fluctuations in the supply voltage caused by the rapid switching of the IGBTs open and closed.

FIG. 2 is a circuit diagram of a module 21 equipped with an isolating circuit 4. The invention particularly advantageously applies to a module 21 equipped with such an isolating circuit 4. In the case where a failure is detected by the control circuit 8, the isolating circuit 4 will advantageously be able to request that this module 21 be isolated in order to ensure the protection of the battery 2 or the continuity of service of the rest of the battery 2. However, as detailed below, the module 21 may advantageously comprise a dedicated control circuit, intended to detect a short-circuit external to the module and to protect the module 21 and its isolating circuit 4 from this short-circuit.

The module 21 comprises terminals B1 and B2 between which it applies its supply potential difference. The isolating circuit 4 comprises two power output poles P and N that are intended to be connected to series-connected modules or to one of the power terminals of the battery 2.

The isolating circuit 4 furthermore comprises two switches 41 and 42 that are made to open/close by the control circuit 24 or by the control circuit 8. The isolating circuit 4 comprises two branches connected in parallel between the poles P and N. A first power branch includes the switch 41 in series with the module 21. A second bypass branch includes the switch 42.

The switch 42 is configured to be normally closed, the switch 41 being configured to be normally open. The switch 41 is configured to selectively open/close the branch including the module 21. The switch 42 is configured to selectively open/close the bypass branch. The closure of the switch 41 is controlled by the circuit 8 or the circuit 24. In the absence of a control signal applied by the circuit 8 or the circuit 24, the switch 41 remains open in order to automatically isolate the module 21 in the case of malfunction. The closure of the switch 42 is controlled by default by the voltage across the terminals B1 and B2. Thus, the normal presence of a voltage across the terminals B1 and B2 keeps the switch 42 closed in the absence of other control signals, thereby ensuring that the module 21 is short-circuited by default in the case of malfunction. The opening of the switch 42 must be actively controlled by the circuit 8 or the circuit 24 in order to apply the voltage of the module 21 across the poles P and N.

The switches 41 and 42 may be MOSFET type transistors, which may easily be appropriately dimensioned at relatively low cost. The transistors 41 and 42 may be nMOS type transistors.

When an external short-circuit appears across the terminals of the battery or of one of the modules, it is necessary to limit the consequences of such a short-circuit. The control circuit 24 according to the invention thus allows the modules 21 to be protected during such a short-circuit. In addition, in the presence of a protection circuit 4 equipped with MOSFET type switches 41 and 42, the control circuit 24 ensures the protection of this circuit 4 by interrupting conduction before the switches 41 and 42 are damaged by excessive heating. Thus the switches 41 and 42 are not destroyed to a short-circuit operation, which would aggravate the consequences of the initial short-circuit.

The invention proposes to analyze the voltage across the output terminals of a battery or of a module and to compare this voltage to a threshold representative of a short-circuit in order to generate a signal for opening an isolating switch when this voltage drops below this threshold.

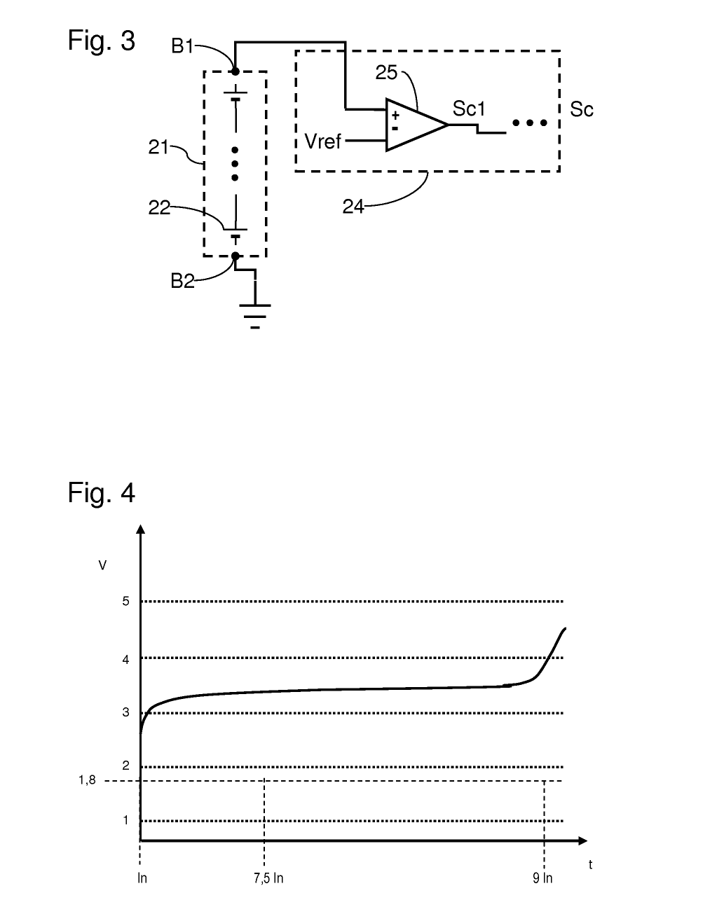

FIG. 3 is a circuit diagram of a first variant of a short-circuit-detecting device included in a control circuit 24 dedicated to the module 21. The control circuit 24 is dedicated to the battery 2. The circuit 24 is intended to detect a short-circuit external to the module 21 and to protect this module 21 and its isolating circuit 4 from this short-circuit. This short-circuit-detecting device comprises a voltage comparator 25. The non-inverting input of the comparator 25 is connected to the (positive) terminal B1 of the module 21, this module 21 including a plurality of electrochemical accumulators 22 connected in series. The input of the comparator 25 is connected to a reference voltage Vref. In order to discriminate an external short-circuit from an excessive discharge of the module 21, the reference voltage Vref is lower than the lower limit of the nominal voltage range of this module 21.

FIG. 4 is a graph especially illustrating the voltage over time across the terminals of an LiFePO₄ type accumulator 22 during its charge or discharge at a nominal current. The nominal operating voltage range of such an accumulator 22 is usually comprised between 2 V and 3.6 V, although most of the operating modes restrict their use to a range comprised between 3.3 V and 3.6 V. Vref is thus set to below N*2, where N is the number of accumulators 22 connected in series in the module 21. The nominal operating voltage range is the voltage range in which an accumulator may be maintained without deteriorating. Designating by Vmin the lower limit of such an operating range, Vref must be lower than N*Vmin. Advantageously, Vref will be lower than or equal to a voltage N*Vinf, where Vinf=Vmin −0.2 V.

Assuming that the voltage across the terminals of the accumulators must remain higher than 2 V, the voltage Vref will be set to a value lower than N*2. The voltage across the terminals of such an accumulator for example dropping by 200 mV (this drop is relatively large for a power battery having non-negligible internal impedances) for a nominal current In, the voltage Vref will possibly be set to a value equal to:

Vref=N*(2−0.2)=N*1.8.

In order to allow a short-circuit to be rapidly detected, the voltage Vref will also advantageously be set to a value higher than or equal to a voltage of N*Vbas, where Vbas=Vmin −0.4 V. Thus, a short-circuit will be detected very quickly without having to wait for prolonged discharge of the accumulators.

When the voltage applied to the non-inverting terminal of the comparator 25 drops below the voltage Vref, an alarm signal Sc1 is generated on the output of the comparator 25. The control circuit 24 may then decide that the conditions of identification of an external short-circuit have been met and may generate a control signal Sc for opening a switch allowing the terminals of the module 21 to be isolated from an electrical load. The control signal Sc may especially be used to open the switch 41 and close the switch 42 of the isolating circuit 4. Thus, the control circuit 24 makes inexpensive detection of an external short-circuit possible, this detection being sufficiently rapid to cut the current before the module 21 or its isolating circuit 4 deteriorate.

As illustrated in FIG. 4, an LiFePO₄ type accumulator 22 achieves the voltage of 1.8 V for a discharge current of:

In if the open-circuit voltage is 2 V;

7.5* In if the open-circuit voltage is 3.3 V; and

9* In if the open-circuit voltage is 3.6 V.

Therefore, a control circuit 24 such as described with reference to FIG. 3 cuts off the current at very different current values depending on the charge of the module 21. The time taken before the current is cut off may therefore prove to be relatively different depending on the charge of the module 21.

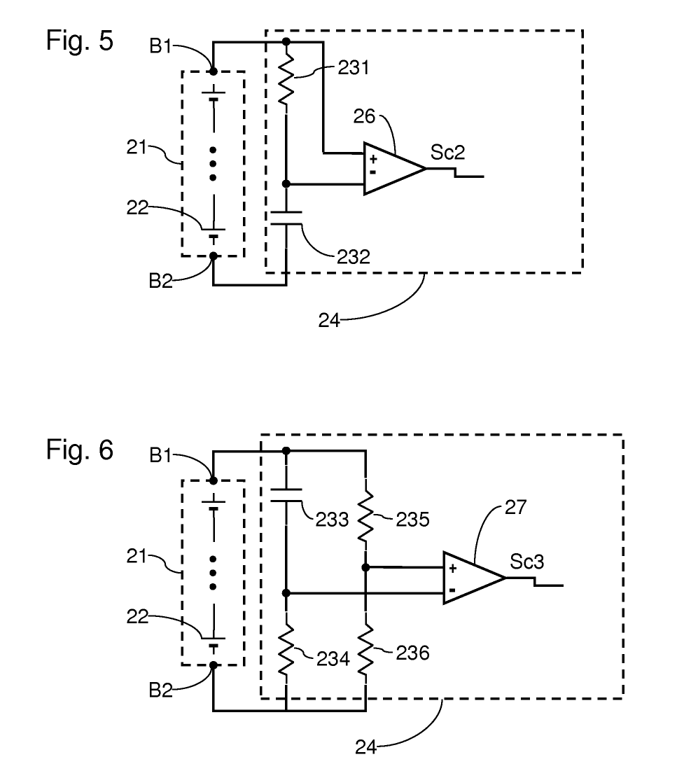

FIG. 5 is a circuit diagram of a second variant of a short-circuit-detecting device that may be included in the control circuit 24. Such a short-circuit-detecting device may be provided as a replacement of or in addition to the comparator 25 in the control circuit 24.

This short-circuit-detecting device comprises a voltage comparator 26. The non-inverting input of the comparator 26 is connected to the terminal B1 of the module 21. A series RC circuit is connected between the terminals B1 and B2 of the module 21. A resistor 231 of the RC circuit is connected between the non-inverting input (by way of a threshold function 237) and the inverting input of the comparator 26. A capacitor 232 is connected between the inverting input of the comparator 26 (by way of the threshold function 237) and the terminal B2 (negative terminal).

The function of the capacitor 232 is to memorize a voltage across the terminals of the module 21. Specifically, the RC circuit has a sufficiently high time constant that the voltage across the terminals of the capacitor 232 remains substantially constant when an external short-circuit causes the voltage across the terminals of the module 21 to vary abruptly. This time constant will for example typically be higher than 1 second. As the charge on the capacitor 232 varies little during normal operation of the module 21, the RC circuit consumes a negligible current. To limit this current, the resistor 231 will however advantageously have a resistance at least equal to 100 kΩ, and preferably higher than 1 MΩ.

Thus, the comparator 26 generates an alarm signal Sc2 only when the voltage memorized in the capacitor 232 is higher than the sum of the voltage across the terminals of the module 21 and of the threshold of the threshold function 237, indicating a rapid drop in the voltage across the terminals of the module 21. The control circuit 24 may then decide that the conditions of identification of an external short-circuit are met and may generate the control signal Sc for opening a switch allowing the terminals of the module 21 to be isolated from an electrical load. Thus, such a control circuit 24 makes inexpensive detection of an external short-circuit possible, this detection being rapid enough to cut the current before the module 21 or its isolating circuit 4 deteriorate. Such a control circuit 24 is then insensitive to the level of charge of the module 21 since the reference voltage used for comparison to the voltage of the module 21 is in fact the voltage across the terminals of the module 21 before the short-circuit. The time taken to cut off the current is then independent of the charge of the module 21. The cut-off conditions of the comparators 25 and 26 may be combined to prevent untimely detection of a short-circuit.

FIG. 6 is a circuit diagram of a third variant of a short-circuit-detecting device that may be included in the control circuit 24. Such a short-circuit-detecting device may be provided in addition to the comparator 25 or the comparator 26 in the control circuit 24.

This short-circuit-detecting device comprises a voltage comparator 27. The non-inverting input of the comparator 27 is connected to a negative threshold function 235. A series RC circuit is connected between the terminals B1 and B2 of the module 21. A resistor 234 of the RC circuit is connected between the inverting input of the comparator 27 and the terminal B2 of the module 21. A capacitor 233 is connected between the inverting input of the comparator 27 and the terminal B1. The RC circuit allows an excessively rapid voltage front across the terminals of the module 21 to be detected.

Here, the time constant is sufficiently low (for example lower than 10 μs) that only rapid voltage fronts, potentially corresponding to short-circuits, are detected.

Thus, the comparator 27 generates an alarm signal Sc3 only when the voltage across the terminals of the module 21 decreases with an excessively rapid front. The control circuit 24 may then decide that the conditions of identification of an external short-circuit have been met and may generate the control signal Sc for opening a switch allowing the terminals of the module 21 to be isolated from an electrical load. Thus, such a control circuit 24 makes inexpensive detection of an external short-circuit possible, this detection being sufficiently rapid to cut the current before the module 21 or its isolating circuit 4 deteriorate. Such a control circuit 24 is then insensitive to the level of charge of the module 21 since it detects a discharge rate. The time taken to cut off the current is then independent of the charge of the module 21. The cut-off conditions of the comparators 25 and 27 or of the comparators 26 and 27 may be combined to prevent untimely detection of a short-circuit.

Although in the detection circuit described in the embodiments, the voltage across the terminals of one module is applied to the detection circuit, the invention also applies to the case where a battery, including a plurality of modules in series, applies the voltage across its terminals to the detection circuit. As a matter of principle, each of the modules including series-connected accumulators is analogous to a battery of accumulators.

1-11. (canceled)

12. A power battery, comprising:
electrochemical accumulators connected in series between two output terminals (B1, B2) of the battery;
a switch allowing one of the output terminals to be selectively isolated from an electrical load; and
a detection circuit for detecting an external short-circuit, to which the voltage between the output terminals of the battery is applied, the detection circuit being configured to:
compare the applied voltage to a voltage threshold representative of a short-circuit; and
generate a signal for opening said switch when the applied voltage drops below said threshold.

13. The power battery as claimed in claim 12, in which the detection circuit compares the applied voltage to a voltage threshold having a preset value lower than or equal to N*Vmin, where N is the number of electrochemical accumulators connected in series between the output terminals and Vmin is the lower limit of the voltage range in nominal operation of each of said accumulators.

14. The power battery as claimed in claim 13, in which the detection circuit compares the applied voltage to a voltage threshold having a preset value lower than or equal to N*Vinf, where Vinf=Vmin −0.2 V.

15. The power battery as claimed in claim 12, in which the detection circuit is configured to memorize a voltage value across the output terminals of the battery, and configured to use subsequently the memorized voltage value as the voltage threshold representative of a short-circuit.

16. The power battery as claimed in claim 15, in which the detection circuit comprises a series RC circuit (having a time constant at least equal to one second and connected between the terminals of the battery, the resistor of said RC circuit having a first electrode connected to the positive terminal of the battery (B1) and to the non-inverting input of a comparator and a second electrode connected to the inverting input of the comparator, the capacitor of said RC circuit having a first electrode connected to the negative terminal of the battery (B2) and a second electrode connected to the inverting input of the comparator, the detection circuit being configured in order to generate a signal for opening said switch when the voltage on the non-inverting input is lower than the voltage on the inverting input.

17. The power battery as claimed in claim 12, in which the detection circuit further comprises:
a voltage divider connected between the terminals (B1, B2) of the battery;
a comparator the non-inverting input of which is connected to an intermediate point of the voltage divider; and
a series RC circuit the capacitor of which is connected between the positive terminal of the battery and the inverting input of the comparator and the resistor of which is connected between the negative terminal of the battery and the inverting input of the comparator.

18. The power battery as claimed in claim 12, comprising at least eight LiFePO₄ lithium-ion type accumulators connected in series.

19. The power battery as claimed in claim 12, comprising an isolating circuit comprising:
first and second power output poles (P,N);
first and second switches, the first switch being a normally open switch and the second switch being a normally closed switch, a supply voltage of said battery being applied by way of closing control signal by default to the second switch; and
first and second branches connected in parallel between the first and second power output poles (P,N), the first branch including the normally open switch and the series-connected accumulators, the second branch being selectively open/closed by the normally closed switch.

20. The power battery as claimed in claim 19, in which said first and second switches of the isolating circuit are MOS type transistors.

21. The power battery as claimed in claim 19, in which said first switch of the isolating circuit is a MOS type transistor and said second switch of the isolating circuit is a JFET type transistor.

22. The power battery as claimed in claim 19, in which said opening signal generated by the detection circuit is applied to a control electrode of the normally open switch in order to force it to open.
